(19) United States
(12) Patent Application Publication
(10) Pub. No.: US 2025/0368520 A1
(43) Pub. Date: Dec. 4, 2025

(54) A SYSTEM AND METHOD FOR PRODUCING AMMONIA

(71) Applicant: Siemens Energy Global GmbH & Co. KG, München (DE)

(72) Inventors: Suhel Ahmad, Duisburg (DE); Peter Adam, Nürnberg (DE); Lukas Biyikli, Ratingen (DE)

(21) Appl. No.: 18/874,129

(22) PCT Filed: Jun. 21, 2023
(86) PCT No.: PCT/EP2023/066869

§ 371 Date: Dec. 12, 2024

(30) Foreign Application Priority Data
Jul. 1, 2022 (DE) 10 2022 206 740.1

(51) Int. Cl. C01C 1/04; C25B 1/04; C25B 15/08

(52) U.S. Cl. CPC C01C 1/0488; C25B 1/04; C25B 15/081

(57) ABSTRACT

The invention relates to a system and a method for producing ammonia, including an ammonia reactor which is formed for the generation of ammonia (NH₃) from a synthesis gas, where the synthesis gas includes hydrogen (H₂) and nitrogen (N₂), further including an electrolizer which is formed to generate hydrogen and oxygen from water, where the electrolizer is operated with renewable energies, further including a gas turbine operated with hydrogen, where the exhaust gas of the gas turbine containing nitrogen (N₂) is employed for the generation of the synthesis gas.

### BACKGROUND

The invention relates to a system and a method for generating ammonia, wherein ammonia (NH₃) is produced from a synthesis gas in an ammonia reactor, wherein the synthesis gas comprises hydrogen (H₂) and nitrogen (N₂).

The generation of ammonia goes back to a known method which usually requires a lot of energy. According to first estimations, currently about 1% of the energy generated worldwide is required for production of ammonia.

The ammonia generated from renewable energies is referred to as green ammonia. Green ammonia is regarded as a fast-growing energy carrier for hydrogen. Furthermore, it is used in many industrial processes, especially in fertilizers. It is estimated that approx. 50% of the green hydrogen which will be produced in the next years will be directly processed to liquid ammonia for long-distance transport of hydrogen as the liquefaction of pure hydrogen is very energy intensive.

The largest energy and compression expenditure, in addition to the hydrogen generation through electrolysis and the nitrogen generation through air separation systems, is synthesis gas compression, which compresses the nitrogen-hydrogen mixture to the pressure of 150-200 bar required for the synthesis process, and the cold box, which provides the cooling energy for the liquefaction and cooling of the ammonia to approx. −33° C. at atmospheric pressure.

Generally, a pre-heating unit for heating the synthesis gas to the reaction temperature is required.

At present, the nitrogen and hydrogen required for the production of ammonia are usually compressed to the required synthesis pressure in a synthesis gas compressor. The suction pressure for this compressor is generally determined by the hydrogen pressure which in case of green ammonia applications, where electrolysis is carried out on site, is limited to the maximum starting pressure of an electrolysis system (max. 30-40 bar).

The shaft power for the compressor is delivered by a steam turbine, while the required steam is generated through the heat which is released during the ammonia synthesis. Pre-warming of the synthesis gas must be either through a fuel- or electricity-fired heater or through use of waste heat of the ammonia process, which reduces the amount of the steam for the steam turbine which can be generated.

Liquefaction is via a refrigerant circuit.

Ammonia is produced in large quantities around the world as an agricultural fertilizer, wherein, however, natural gas or other fossil fuels are used in order to provide both the hydrogen as a starting material and the energy for the synthesis process. As a result, ammonia production causes almost 1.5% of CO₂ emissions worldwide with these methods.

With commitments made to achieve net-zero emissions targets, new zero-carbon fuels such as green ammonia and green hydrogen are needed to decarbonize energy generation, heat supply, transport and industry.

It is estimated that approx. 50% of the green hydrogen which will be produced in the next years will be converted into green ammonia.

Ammonia can be used as a convenient hydrogen energy carrier and the already existing industry, which produces, stores and trades millions of tons of ammonia every year, means that the infrastructure and the technology are already existent in order to launch the hydrogen economy.

The most important energy and compression expenditure, in addition to the hydrogen generation through electrolysis and the nitrogen generation through air separation systems, is synthesis gas compression, which compresses the nitrogen-hydrogen mixture to the pressure of 150-200 bar required for the synthesis process, and the cold box, which delivers the cooling energy for the liquefaction and cooling of the ammonia to approx. −33° C. at atmospheric pressure.

In conventional ammonia production, the hydrogen gas (H₂) is obtained from the steam methane reforming (SMR), the most common method for the generation of hydrogen, and the nitrogen gas (N₂) is either obtained from air or from an air separation system.

N₂ and H₂ are mixed stoichiometrically (1:3) and compressed with a syngas compressor and guided into an ammonia synthesis reactor at a pressure of 150 to 220 bar. The ammonia synthesis gas reactor operates at an operating temperature of approx. 500° C. The process is exothermal, the large amount of heat of 46 KJ/mol of ammonia is released and utilized for steam generation. After the reaction, approx. 25% of ammonia are obtained as a product, the rest is returned via a circulation compressor. The generated ammonia is then liquefied through cryogenic distillation.

### SUMMARY

The invention is based on the object of providing an improved system and an improved method for producing ammonia, in particular with regard to the employment of the energy required for the production of ammonia.

The invention proposes an innovative concept for an environmentally friendly ammonia system through integration of an electrolizer with renewable energy.

The advantages of the system according to the invention and the method according to the invention include more efficient, environmentally friendly and economical processes for green hydrogen and green ammonia, the integration of GT exhaust gases operated with H₂ enables the generation of N₂ and green electrical/mechanical drive energy as well as water for electrolysis, and lower power consumption through the pipeline transport of N₂—H₂ mixtures with higher safety, operational flexibility and longer pipeline life compared to the transport of lean H₂ over long distances. In addition, the advantages of the system according to the invention and the method according to the invention also include the use of pressurized O₂ for the conversion into electricity increases overall efficiency and supports the operation of the system with fluctuating renewable energy and more efficient, environmentally friendly and economical processes for green hydrogen and green ammonia.

### BRIEF DESCRIPTION OF THE DRAWINGS

The characteristics, features and advantages of this invention described above, as well as the manner in which these are achieved, will be more clearly and fully understood in connection with the following description of the exemplary embodiments, which will be explained in more detail in connection with the drawings.

Identical components or components with the same function are marked with the same reference numerals.

Exemplary embodiments of the invention are described hereinafter with the drawings. These are not intended to represent the exemplary embodiments to scale; rather, where useful for explanation, the drawing is carried out in a schematic and/or slightly distorted form. With regard to additions to the teachings immediately visible in the drawing, reference is made to the relevant state of the art.

In the drawings:

FIG. 1 a schematic representation of a system for the generation of ammonia

### DETAILED DESCRIPTION

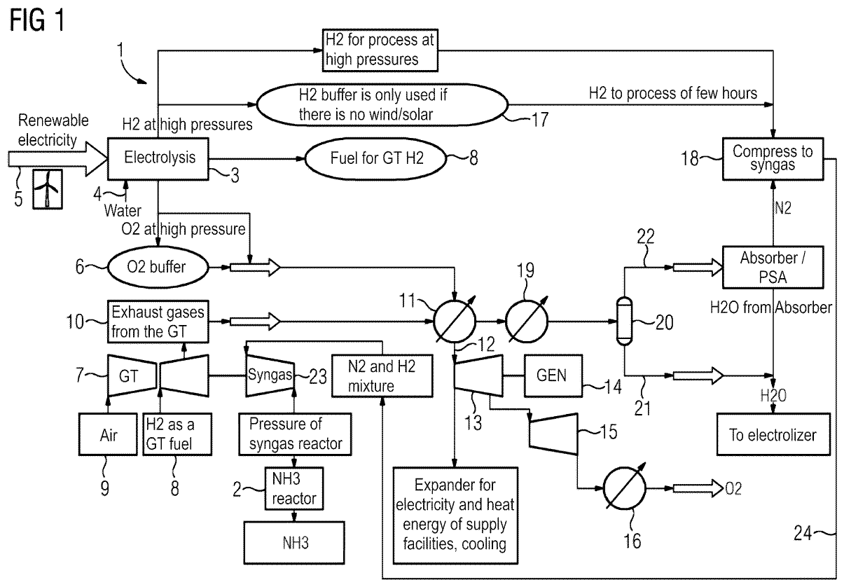

As represented in FIG. 1, the electrolizer receives electrical energy from renewable energies, such as wind power or photovoltaics, for example, and produces H₂ and O₂ (approx. 8 times more than H₂ by mass). These gases are generated under pressure (1-30 bar). Normally, O₂ is not used, but discharged.

According to the invention, the pressurized O₂ is heated in a waste heat boiler with the waste gas of a gas turbine and then expanded in a hot gas expander in order to generate mechanical or electrical energy. This energy can be utilized in some supply or auxiliary facilities.

For the ammonia method, N₂ and H₂ are required as starting materials, which are mixed stoichiometrically in the ratio 1:3. In a conventional system, the N₂ is supplied from an air separation system or from the air, while the H₂ is mainly obtained from steam methane reforming.

According to the invention, the N₂ from the exhaust gas of a gas turbine operated with hydrogen is separated (with the help of absorber/PSA unit) so that no air separation system is required. The water vapor from the gas turbine exhaust gas is condensed and is available as water use material for the electrolize system (up to 15% of the required water use).

The separated N₂ from the GT exhaust gas is stoichiometrically mixed with H₂ from the electrolysis system in order to generate the required synthesis gas mixture from the ammonia synthesis.

The synthesis gas mixture (molar weight 8 g/mol) is then compressed to pipeline pressure and transported to the site of the ammonia system with the ammonia reactor 2. This syngas transport requires less energy than the pure H₂ transport and enables a secure pipeline operation compared to the lean H₂ transport.

In order to support ammonia production (at reduced capacity), a hydrogen and oxygen buffer is integrated in order to provide reduced hydrogen to the ammonia system and the GT fuel, as well as oxygen for the expander for times when renewable energy is not available. The capacity of the buffer depends on the duration of time without sustainable power supply and the minimum capacity of the ammonia synthesis.

A synthesis gas is supplied in the ammonia reactor 2. The synthesis gas comprises hydrogen (H₂) and nitrogen (N₂). The hydrogen (H₂) and nitrogen (N₂) react in the ammonia reactor 2 according to the chemical reaction

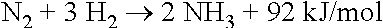

This chemical reaction is a strongly exothermal reaction, i.e. the ammonia NH₃ created in the ammonia reactor has a comparably high temperature, wherein this high temperature is used according to the invention for pre-warming the nitrogen N₂.

Here, a detailed representation of the ammonia reactor 2 is dispensed with.

The system 1 comprises an electrolizer 3 which is fed with water 4 and separates water into hydrogen and oxygen with the help of renewable energies 5.

The oxygen is supplied to a first buffer storage 6. The hydrogen is partly provided as fuel for a gas turbine 7. The guidance of the hydrogen as a fuel for the gas turbine 7 is indicated symbolically with reference numeral 8.

For operation of the gas turbine 7, air 9 is also required in addition to hydrogen, wherein usually ambient air is used.

The hot exhaust gas 10 from the gas turbine 7 is supplied to a heat exchanger 11. The oxygen located in the buffer storage 6 is supplied in the heat exchanger 11, wherein the temperature of the oxygen is heated through the hot exhaust gas 10 of the gas turbine 7.

The heated oxygen is supplied to an expander 13 via a line 12.

In the expander 13, the thermal energy of the oxygen is converted into mechanical energy. The mechanical energy is used to drive an electrical generator 14.

The exhaust gas from the expander 13 is then supplied to further components: second expander 15, heat exchanger 16.

Another part of the hydrogen from the electrolizer 3 is supplied to a further buffer storage 17, wherein this buffer storage 17 serves to make energy available if the energy from the renewable energies is not available.

The exhaust gas 10 from the gas turbine 7 cooled down after the heat exchanger 11 is supplied to a further heat exchanger 19 and then guided into a separation unit 20. In the separation unit 20, the exhaust gas is separated into water 21 and nitrogen 22. The water 21 is supplied to the electrolizer.

A further part of the hydrogen from the electrolizer 3 is supplied to a synthesis gas compressor 18. The nitrogen 22 from the separation unit 20 is also supplied to the synthesis gas compressor 18. The synthesis gas thus created is compressed in the synthesis gas compressor 18 and transported to the ammonia reactor 2 (partly over a larger distance) in a line 24.

The compressor 23 required for production of ammonia is driven via the gas turbine 7.

1. A system for producing ammonia, comprising:
an ammonia reactor which is formed for generation of ammonia (NH₃) from a synthesis gas, wherein the synthesis gas comprises hydrogen (H₂) and nitrogen (N₂);
an electrolizer which is formed to generate hydrogen and oxygen from water,
wherein the electrolizer is operated with renewable energies; and
a gas turbine operated with hydrogen,
wherein
an exhaust gas of the gas turbine containing nitrogen (N₂) is employed for generation of the synthesis gas.

2. The system according to claim 1, wherein the hydrogen (H₂) generated from the electrolizer is mixed with the nitrogen (N₂) generated from the exhaust gas of the gas turbine in order to generate the synthesis gas.

3. The system according to claim 2, further comprising a first compressor for compressing the synthesis gas.

4. The system according to claim 3, further comprising a separation unit which is formed to separate the exhaust gas from the gas turbine into nitrogen and water, wherein the nitrogen is employed for the synthesis gas, wherein the water is supplied to the electrolizer.

5. The system according to claim 1, with a first buffer storage for oxygen which was obtained from the electrolizer.

6. The system according to claim 5, with a heat exchanger which is formed such that the hot exhaust gas from the gas turbine heats the oxygen flowing out of the first buffer storage.

7. The system according to claim 6, with an expander which is formed such that the thermal energy of the oxygen from the first buffer storage is converted into mechanical energy.

8. The system according to claim 7, with a generator which is formed for the generation of electrical energy and is driven by the expander.

9. The system according to claim 1, wherein the synthesis gas compressed in the first compressor is guided to a second synthesis gas compressor, wherein the second synthesis gas compressor is driven with the gas turbine.

10. The system according to claim 9, wherein the flowing out of the second synthesis gas compressor is supplied to the ammonia reactor.

11. A method for producing ammonia,
wherein ammonia (NH₃) is generated from a synthesis gas in an ammonia reactor, wherein the synthesis gas comprises hydrogen (H₂) and nitrogen (N₂),
wherein hydrogen and oxygen are generated in an electrolizer using renewable energies and the hydrogen is used for operating a gas turbine which drives a synthesis gas compressor.

12. The method according to claim 11, wherein a heat exchanger is employed which is formed such that the exhaust gas from the gas turbine heats the oxygen obtained from the electrolizer.

13. The method according to claim 12, wherein an expander is used which is operated with the heated oxygen from the heat exchanger.

14. The method according to claim 13, wherein a generator is employed which is operated with the expander, wherein the generator is formed for the generation of electrical energy.

15. The method according to claim 11, wherein a separation unit is used with which the exhaust gas from the gas turbine is separated into hydrogen and water.

16. The method according to claim 15, wherein the water is guided to the electrolizer.
